(19) United States
(12) Patent Application Publication
(10) Pub. No.: US 2025/0012707 A1
(43) Pub. Date: Jan. 9, 2025

(54) INFORMATION PROCESSING DEVICE AND INFORMATION PROCESSING METHOD

(71) Applicant: SONY GROUP CORPORATION, TOKYO (JP)

(72) Inventors: TOMOHITO ODA, TOKYO (JP); TAKUYA MOTOISHI, TOKYO (JP); HIROTAKA TANAKA, TOKYO (JP)

(21) Appl. No.: 18/711,843

(22) PCT Filed: Oct. 12, 2022
(86) PCT No.: PCT/JP2022/038024

§ 371 Date: May 20, 2024

(30) Foreign Application Priority Data
Nov. 26, 2021 (JP) 2021-192214

(51) Int. Cl. G01N 19/04

(52) U.S. Cl. CPC G01N 19/04

(57) ABSTRACT

An information processing device according to an aspect of the present disclosure includes an estimation section and a determination section. The estimation section estimates adhesion between a contact surface of a base section and a contact target surface to which the base section is attached, on the basis of data that is obtained with use of a sensor and correlated with the adhesion. The determination section determines stability of the base section with respect to the contact target surface, on the basis of the adhesion estimated by the estimation section.

### TECHNICAL FIELD

The present disclosure relates to an information processing device, and an information processing method.

### BACKGROUND ART

With regard to arm stands for fixing a book or electronic equipment such as a smartphone, camera, microphone, or light in the air, a fixation structure on a base side is important to prevent a fall. As the fixation structure, clamping a desk or widening the area of the base is often adopted. In addition, there are ways to fix such abase portion through a magnet or vacuum suction in consideration of downsizing or a degree of freedom of disposing the arm stand on a flat surface, an inclined surface, a sidewall, or the like (for example, PTL 1).

### CITATION LIST

### Patent Literature

PTL 1: Japanese Unexamined Patent Application Publication No. H06-155368

### SUMMARY OF THE INVENTION

However, when fixing the base portion through the magnet, adhesion of the arm stand relies on magnetic force of material included in a thing to which the base section is attached. Alternatively, when fixing the base portion through the vacuum suction, adhesion of the arm stand relies on surface asperity of a thing to which the base section is attached. Therefore, there has been a problem that it is difficult for users to distinguish the degree of stability of the arm stand with respect to center-of-gravity balance when the arm stand is installed at any place. In particular, when an arm portion is motorized, the stability of the arm stand varies due to change in its acceleration or center of gravity caused by movement of the arm portion. This makes it more difficult for the users to distinguish the stability of the arm stand. Therefore, it is desirable to provide an information processing device or information processing method that make it possible to objectively recognize the stability or to control operation of the arm portion in such a way as to ensure the stability.

An information processing device according to a first aspect of the present disclosure includes an estimation section and a determination section. The estimation section estimates adhesion between a contact surface of a base section and a contact target surface to which the base section is attached, on the basis of data that is obtained with use of a sensor and correlated with the adhesion. The determination section determines stability of the base section with respect to the contact target surface, on the basis of the adhesion estimated by the estimation section.

An information processing method according to a second aspect of the present disclosure includes:
(A) estimating adhesion between a contact surface of a base section and a contact target surface to which the base section is attached, on the basis of data that is obtained with use of a sensor and correlated with the adhesion; and
(B) determining stability of the base section with respect to the contact target surface, on the basis of the estimated adhesion.

When using the information processing device according to the first aspect of the present disclosure and the information processing method according to the second aspect of the present disclosure, the adhesion between the contact surface of the base section and the contact target surface to which the base section is adhered is estimated on the basis of the data obtained with use of the sensor, and the stability of the base section with respect to the contact target surface is determined on the basis of the estimated adhesion. This allows users to recognize whether or not the base section has sufficient stability with respect to the contact target surface when the base section is installed on any surface, and to move an arm coupled to the base section in such a manner that the stability of the base section is ensured with respect to the contact target surface.

### BRIEF DESCRIPTION OF DRAWING

FIG. 1 is a diagram illustrating a schematic configuration example of an arm stand according to a first embodiment of the present disclosure.

FIG. 2 is a diagram illustrating a functional block example of the arm stand illustrated in FIG. 1.

FIG. 3 is a diagram illustrating an example of operation of the arm stand illustrated in FIG. 1.

FIG. 4 is a diagram illustrating an example of operation after FIG. 3.

FIG. 5 is a diagram illustrating a modification of functional blocks of the arm stand illustrated in FIG. 1.

FIG. 6 is a diagram illustrating a modification of the functional blocks of the arm stand illustrated in FIG. 1.

FIG. 7 is a diagram illustrating a modification of the functional blocks of the arm stand illustrated in FIG. 1.

FIG. 8 is a diagram illustrating a modification of the schematic configuration of the arm stand illustrated in FIG. 1.

FIG. 9 is a diagram illustrating a schematic configuration example of a robotic arm according to a second embodiment of the present disclosure.

FIG. 10 is a diagram illustrating a functional block example of the robotic arm illustrated in FIG. 9.

FIG. 11 is a diagram illustrating an example of operation of the robotic arm illustrated in FIG. 9.

FIG. 12 is a diagram illustrating a modification of the functional blocks of the robotic arm illustrated in FIG. 9.

FIG. 13 is a diagram illustrating a situation where the arm stand illustrated in FIG. 1 is attached to a mobile object.

FIG. 14 is a diagram illustrating a functional block example of the arm stand and the mobile object illustrated in FIG. 13.

FIG. 15 is a diagram illustrating a modification of the functional blocks of the arm stand and the mobile object illustrated in FIG. 13.

FIG. 16 is a diagram illustrating a situation where the robotic arm illustrated in FIG. 9 is attached to a mobile object.

FIG. 17 is a diagram illustrating a functional block example of the robotic arm and the mobile object illustrated in FIG. 16.

FIG. 18 is a diagram illustrating a modification of the functional blocks of the robotic arm and the mobile object illustrated in FIG. 16.

### MODES FOR CARRYING OUT THE INVENTION

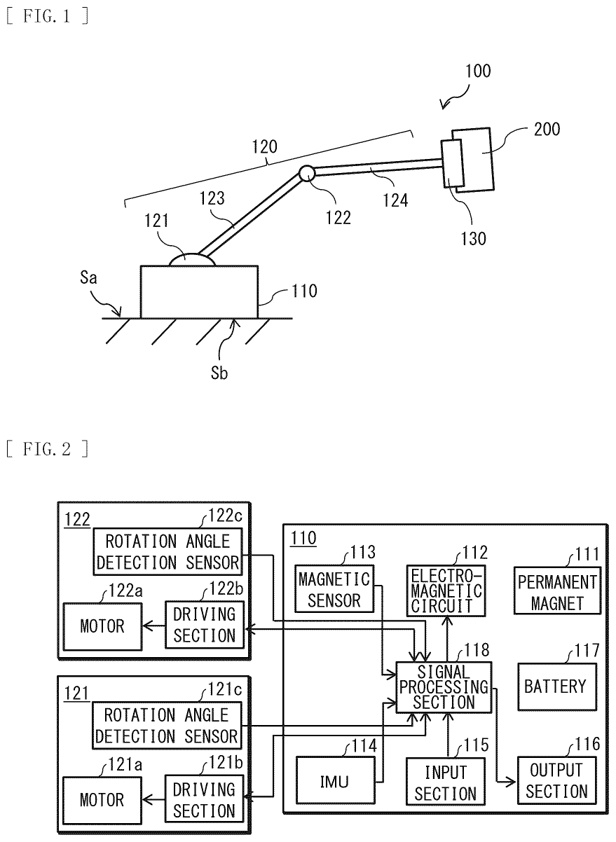

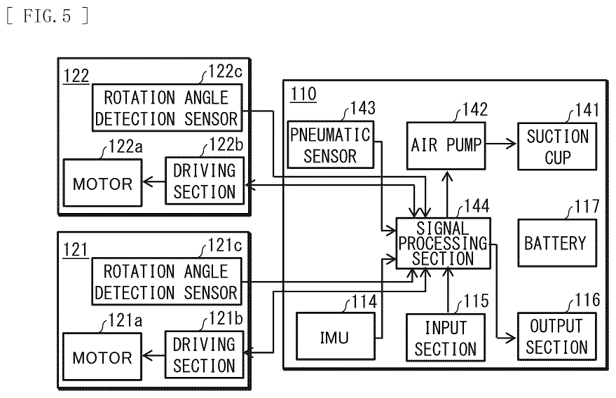

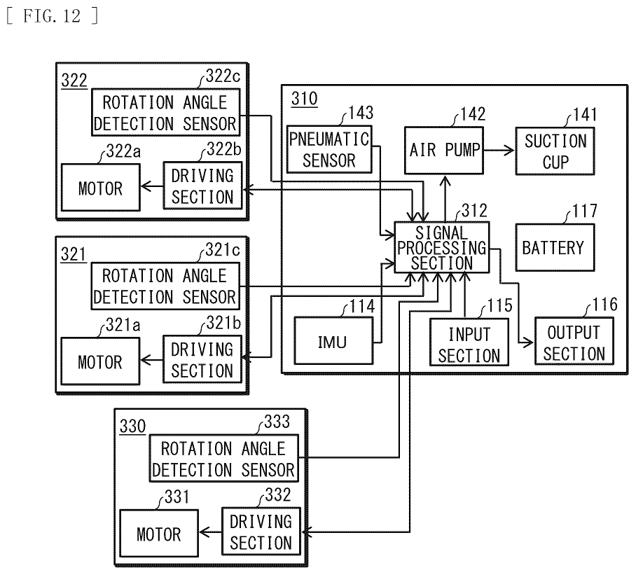

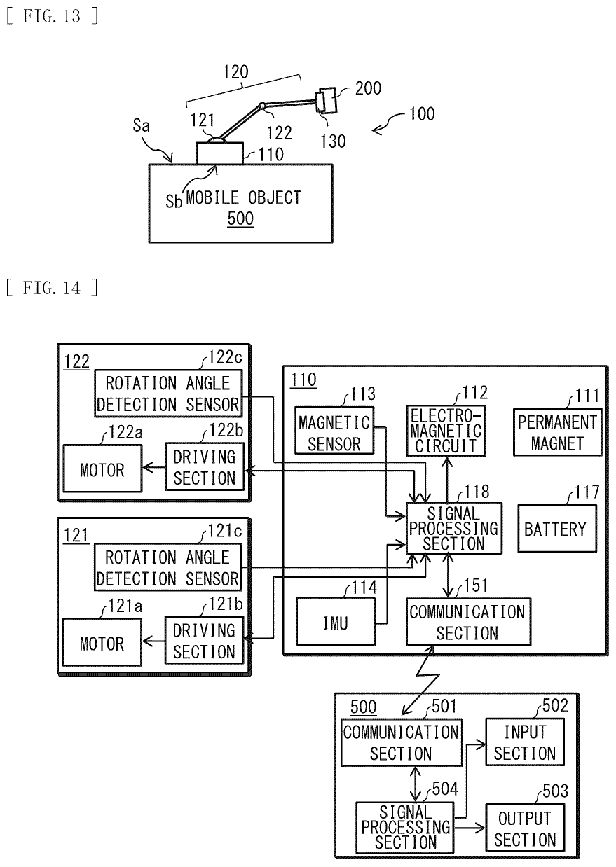

Hereinafter, embodiments for carrying out the present disclosure will be described in detail with reference to the drawings. It is to be noted that the description will be given in the following order.
1. First Embodiment (FIG. 1 to FIG. 4): Arm Stand
2. Modification of First Embodiment (FIG. 5 to FIG. 8)
3. Second Embodiment (FIG. 9 to FIG. 11): Robotic Arm
4. Modification of Second Embodiment (FIG. 12)
5. Modification Common to Both Embodiments (FIG. 13 to FIG. 18)

### 1. First Embodiment

### [Configuration]

FIG. 1 illustrates a schematic configuration example of an arm stand 100 according to a first embodiment of the present disclosure. FIG. 2 illustrates a functional block example of the arm stand 100. The arm stand 100 is a device for fixing a fixation target object 200 in the air. For example, as illustrated in FIG. 1, the arm stand 100 includes a base section 110, an arm 120, and a fixture section 130.

The base section 110 has a bottom surface that is adhered to and in contact with a contact target surface Sa. Hereinafter, the bottom surface of the base section 110 will be referred to as a contact surface Sb. The contact target surface Sa is a surface of a predetermined object (for example, a table, wall, or mobile object (such as a vehicle or drone)). According to the present embodiment, a permanent magnet and an electromagnet are installed near the contact surface Sb of the base section 110, the contact target surface Sa of the predetermined object includes metal material, and the contact surface Sb of the base section 110 is adhered to the contact target surface Sa through magnetic force of the permanent magnet and electromagnet. The magnetic force of the permanent magnet and electromagnet corresponds to a specific example of “adhesion” according to the present disclosure.

### (Base Section 110)

For example, as illustrated in FIG. 2, the base section 110 includes a permanent magnet 111, an electromagnetic circuit 112, a magnetic sensor 113, an inertial measurement unit (IMU) 114, an input section 115, an output section 116, a battery 117, and a signal processing section 118.

For example, the electromagnetic circuit 112 includes magnetic material, a coil wound around the magnetic material, an electric current source that applies electrical current to the coil, and a control circuit that controls the electric current source. The control circuit controls the electric current source on the basis of a control signal from the signal processing section 118 and thereby causes the coil to generate magnetic force depending on magnitude of the electric current flowing the coil. The magnetic sensor 113 detects magnetic flux density generated from the permanent magnet 111 and the electromagnetic circuit 112, and outputs a detection signal obtained through the detection to the signal processing section 118. For example, the magnetic sensor 113 is a Hall sensor, and outputs a voltage signal proportional to magnitude of the detected magnetic flux density. Data (detection signal and voltage signal) obtained by the magnetic sensor 113) is data correlated with the adhesion between the contact surface Sb of the base section 110 and the contact target surface Sa to which the base section 110 is adhered. The IMU 114 includes an acceleration sensor that detects translational motion in orthogonal triaxial directions, and an angular velocity (gyro) sensor that detects rotational motion. The IMU 114 detects three-dimensional inertial motion (rotational motion and translational motion in orthogonal triaxial directions), and outputs a detection signal obtained from the detection to the signal processing section 118.

The input section 115 accepts input from a user. For example, the input section 115 accepts a setting of at least a movable range among the movable range and acceleration of the arm 120, and outputs the accepted setting to the signal processing section 118. For example, the input section 115 includes a touchscreen. For example, the output section 116 includes a display panel, and displays information generated by the signal processing section 118. The battery 117 supplies electric power to various kinds of electric circuits or electronic circuits included in the base section 110 and the arm 120.

The signal processing section 118 includes, for example, a central processing unit (CPU). The signal processing section 118 calculates total moment and total weight (arm 120, fixture section 130, and fixation target object 200) on the basis of various kinds of signals obtained from joint sections 121 and 122 (to be described later). The signal processing section 118 further estimates adhesion between the contact surface Sb and the contact target surface Sa on the basis of a detection signal obtained from the magnetic sensor 113. For example, the signal processing section 118 derives a difference between a detection signal obtained from the magnetic sensor 113 when the contact surface Sb is not adhered to the contact target surface Sa (non-adhered state) and a detection signal obtained from the magnetic sensor 113 when the contact surface Sb is adhered to the contact target surface Sa (adhered state). For example, the signal processing section 118 estimates the adhesion by substituting the different obtained as described above into an equation (1) listed below, where ΔB represents change in the magnetic flux density. It is to be noted that the estimation of the adhesion is not limited to the equation (1) listed below. In addition, the signal processing section 118 determines stability of the base section 110 with respect to the contact target surface Sa, on the basis of the calculated total weight, the calculated total moment, and the estimated adhesion.

$$F = α \times Δ B + β \qquad Equation ( 1 )$$

where F represents adhesion (magnetic force (N)).
ΔB represents measured change in magnetic flux density, and
α and β represent experimentally obtained parameters.

### (Arm 120)

For example, as illustrated in FIG. 1, the arm 120 includes the joint sections 121, 122, a first arm 123, and a second arm 124. For example, as illustrated in FIG. 2, the joint section 121 includes a motor 121a, a driving section 121b, and a rotation angle detection sensor 121c. The motor 121a pivots the first arm 123. The driving section 121b drives the motor 121a under the control of the signal processing section 118. The rotation angle detection sensor 121c detects a rotation angle of the motor 121a. The driving section 121b outputs a measurement value of electric current to be applied to the motor 121a (electric current information of motor 121a), to the signal processing section 118. The rotation angle detection sensor 121c outputs the detected rotation angle of the motor 121a (angular information of motor 121a), to the signal processing section 118. For example, the rotation angle detection sensor 121c includes an encoder.

For example, as illustrated in FIG. 2, the joint section 122 includes a motor 122a, a driving section 122b, and a rotation angle detection sensor 122c. The motor 122a pivots the second arm 124. The driving section 122b drives the motor 122a under the control of the signal processing section 118. The rotation angle detection sensor 122c detects a rotation angle of the motor 122a. The driving section 122b outputs a measurement value of electric current to be applied to the motor 122a (electric current information of motor 122a), to the signal processing section 118. The rotation angle detection sensor 122c outputs the detected rotation angle of the motor 122a (angular information of motor 122a), to the signal processing section 118. For example, the rotation angle detection sensor 122c includes an encoder.

One end of the first arm 123 is fixed to a rotation shaft of the motor 121a of the joint section 121, and another end of the first arm 123 is fixed to a casing that fixes the motor 121a of the joint section 122. One end of the second arm 124 is fixed to a rotation shaft of the motor 122a of the joint section 122, and another end of the second arm 124 is fixed to the fixture section 130.

### (Fixture Section 130)

The fixture section 130 includes a mechanism to which the fixation target object 200. The fixture section 130 is fixed to the one end of the second arm 124. Therefore, a position of the fixation target object 200 with respect to the second arm 124 is constantly fixed.

Meanwhile, for example, the signal processing section 118 calculates the total weight and total moment on the basis of various kinds of signals (such as angular information/electric current information of the motors 121a and 122a) obtained from joint sections 121 and 122 (to be described later).

For example, the signal processing section 118 calculates an angle of the first arm 123 with respect to the joint section 121, from the angular information of the motor 121a. For example, the signal processing section 118 calculates an angle of the second arm 124 with respect to the joint section 122, from the angular information of the motor 122a. For example, the signal processing section 118 estimates torque applied to the fixture section 130 from the electric current information of the motors 121a and 122b, and estimates weights of the fixation target object 200 and the fixture section 130 from the estimated torque. In a case where the weight of the arm 120 is previously known, the signal processing section 118 calculates the total weight by adding the known weight of the arm 120 and the estimated weights of the fixation target object 200 and the fixture section 130, for example.

For example, the signal processing section 118 estimates a total center-of-gravity position from the calculated total weight, the calculated angle of the first arm 123, and the calculated angle of the second arm 124. For example, the signal processing section 118 calculates moment (total moment) applied to the contact surface Sb on the basis of the estimated total center-of-gravity position, the calculated total weight, and inclination of the base section 110 obtained by the IMU 114.

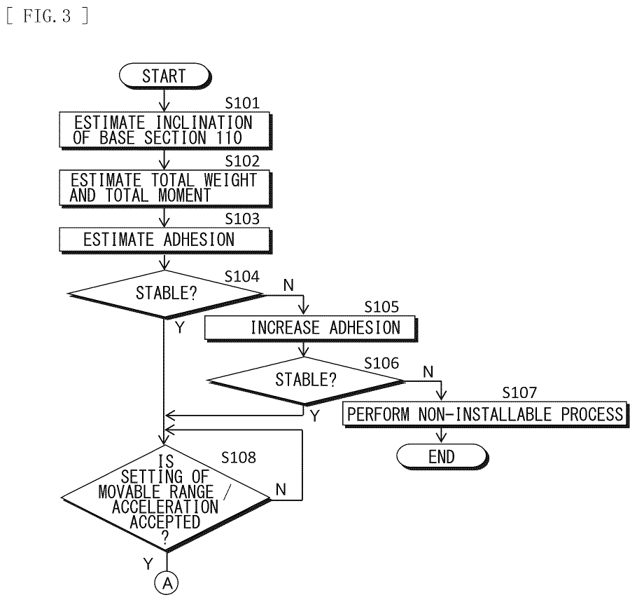

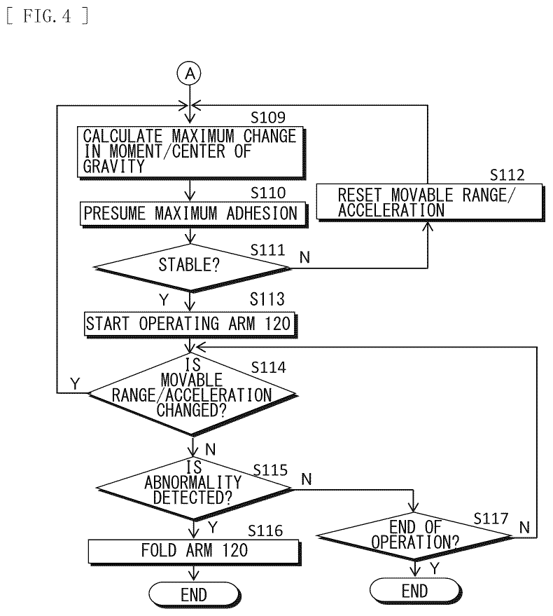

Next, with reference to FIG. 3 and FIG. 4, operation of the arm stand 100 will be described. FIG. 3 illustrates an example of operation of the arm stand 100. FIG. 4 illustrates an example of operation of the arm stand 100 after FIG. 3.

First, the user installs the base section 110 of the arm stand 100 on the contact target surface Sa. Then, the signal processing section 118 estimates inclination of the base section 110 on the basis of a detection signal input from the IMU 114 (Step S101).

Next, the signal processing section 118 calculates total weight and total moment on the basis of various kinds of signals (such as angular information/electric current information of the motors 121a and 122a) obtained from joint sections 121 and 122 (Step S102). Next, the signal processing section 118 estimates adhesion (magnetic force of the permanent magnet and electromagnet) on the basis of a detection signal obtained from the magnetic sensor 113 (Step S103). For example, the signal processing section 118 estimates the adhesion by measuring change in magnetic flux density between a contact state and a non-contact state from the detection signal obtained from the magnetic sensor 113 and substituting the measured change in magnetic flux density into the above-listed equation (1). The detection signal in the non-contact state may be acquired immediately before the user installs the base section 110 of the arm stand 100 on the contact target surface Sa. Alternatively, a memory or the like built in the base section 110 may previously store a detection signal in the non-contact state that is previously acquired before shipment of the arm stand 100 from a factory.

In addition, the signal processing section 118 determines stability of the base section 110 with respect to the contact target surface Sa, on the basis of the calculated total weight, the calculated total moment, and the estimated adhesion (Step S104). As a result, the signal processing section 118 increases the adhesion by controlling the electromagnetic circuit 112 (Step S105) in a case where it is determined that the arm stand 100 is not stable (in other words, there is a high possibility that the arm stand 100 will fall down) (N in Step S104). For example, the signal processing section 118 estimates the adhesion that is necessary to obtain the stability against the calculated total weight and total moment, and controls the electromagnetic circuit 112 in such a manner that the estimated adhesion is obtained. In other words, the signal processing section 118 generates a control signal to control the electromagnetic circuit 112 on the basis of a result of determining the stability. Next, the signal processing section 118 reestimates adhesion and redetermines stability (Step S106). As a result, the signal processing section 118 performs a non-installable process (such as a series of processes to fold the arm 120) (Step S107) in a case where it is determined that the arm stand 100 is still not stable (N in Step S106).

Meanwhile, in a case where it is determined that the arm stand 100 is stable (in other words, there is a low possibility that the arm stand 100 will fall down) (Y in Step S104 and Y in Step S106) in Step S104 and Step S106, the signal processing section 118 determines whether or not the setting of at least the movable range is accepted among the movable range and the acceleration of the arm 120 (Step S108). Input of the setting of at least the movable range among the movable range and the acceleration of the arm 120 means causing the arm 120 to operate in the set range.

As a result, the signal processing section 118 calculates maximum change in moment/center of gravity assumed from the setting of any of the movable range or the acceleration of the arm 120 (Step S109) in a case where the setting of at least the movable range is accepted among the movable range and the acceleration of the arm 120 (Y in Step S108). Meanwhile, the signal processing section 118 waits for acceptance of the setting of any of the movable range or the acceleration of the arm 120 (N in Step S108) in a case where the setting of neither the movable range nor the acceleration of the arm 120 is accepted (N in Step S108).

Next, the signal processing section 118 presumes maximum adhesion on the basis of the calculated maximum change in moment/center of gravity (Step S110). Next, the signal processing section 118 determines stability of the base section 110 with respect to the contact target surface Sa, on the basis of the presumed maximum adhesion (Step S111). For example, the signal processing section 118 determines whether or not it is possible for the arm stand 100 to output the presumed maximum adhesion.

As a result, in a case where it is determined that the arm stand 100 is not stable (for example, in a case where it is determined that it is difficult for the arm stand 100 to output the maximum adhesion) (N in Step S111), the signal processing section 118 accepts resetting of any of the movable range or the acceleration of the arm 120 (Step S112), and proceeds to Step S109. Meanwhile, in a case where it is determined that the arm stand 100 is stable in Step S111 (for example, in a case where it is determined that it is possible for the arm stand 100 to output the maximum adhesion) (Y in Step S111), the signal processing section 118 generates a control signal to control the electromagnetic circuit 112 in such a manner that the maximum adhesion is obtained, and outputs the generated control signal to the electromagnetic circuit 112. Subsequently, the signal processing section 118 starts operation of the arm 120 (Step S113).

In a case where the signal processing section 118 has accepted the setting of any of the movable range or acceleration of the arm 120 (Yin Step S114), the signal processing section 118 calculates maximum change in moment/center of gravity assumed from the accepted setting (Step S109). Subsequently, the signal processing section 118 executes Step S110 and Step S111. In a case where the signal processing section 118 has accepted the setting of neither of the movable range nor acceleration of the arm 120 (N in Step S114), the signal processing section 118 determines whether or not the arm stand 100 has abnormality (Step S115).

Here, for example, the abnormality means abnormality in the inclination of the base section 110 obtained from the IMU 114, abnormality in magnitude of magnetism obtained from the magnetic sensor 113, or the like. As a result, the signal processing section 118 executes a process of folding the arm 120 (Step S116) in a case where the abnormality is detected (Y in Step S115). Meanwhile, the signal processing section 118 ends operation of the arm 120 (Step S117) in a case where the abnormality is not detected (N in Step S115). In such a way, the arm stand 100 operates.

### [Effects]

Next, effects of the arm stand 100 will be described.

In the present embodiment, the adhesion between the contact surface Sb of the base section 110 and the contact target surface Sa to which the base section 110 is adhered is estimated on the basis of the data obtained with use of the magnetic sensor 113, and the stability of the base section 110 with respect to the contact target surface Sa is determined on the basis of the estimated adhesion. This allows the user to recognize whether or not the base section 110 has sufficient stability with respect to the contact target surface Sa when the base section 110 is installed on any surface, and to move the arm 120 coupled to the base section 110 in such a manner that the stability of the base section 110 is ensured with respect to the contact target surface Sa. Therefore, it is possible to objectively recognize the stability or to control operation of the arm 120 in such a manner that the stability is ensured.

In the present embodiment, the control signal to control the electromagnetic circuit 112 provided in the base section 110 is generated on the basis of a result of determining the stability. This makes it possible to control the electromagnetic circuit 112 in such a manner that the adhesion of the base section 110 to the contact target surface Sa increases. Therefore, it is possible to control operation of the arm 120 in such a manner that the stability is ensured.

In the present embodiment, the maximum adhesion that is necessary to ensure the stability of the base section 110 with respect to the contact target surface Sa is calculated on the basis of at least the movable range among the movable range and the acceleration of the arm 120. In addition, the control signal to control the electromagnetic circuit 112 is generated in such a manner that the calculated maximum adhesion is obtained. Therefore, it is possible to control operation of the arm 120 in such a manner that the stability is ensured.

In the present embodiment, the maximum adhesion is calculated on the basis of the movable range and the acceleration obtained through input from the user. This makes it possible to generate the control signal to control the electromagnetic circuit 112 in such a manner that the calculated maximum adhesion is obtained. Therefore, it is possible to control operation of the arm 120 in such a manner that the stability is ensured.

### 2. Modifications of First Embodiment

Next, modifications of the arm stand 100 according to the above-described embodiment will be described.

### Modification 1-1

FIG. 5 illustrates a modification of the functional blocks of the arm stand 100. An arm stand 100 according to the present modification is a stand that utilizes not the adhesion caused by magnetic force but adhesion caused by air pressure. The air pressure corresponds to a specific example of the “adhesion” according to the present disclosure. The arm stand 100 according to the present modification includes a suction cup 141, an air pump 142, a pneumatic sensor 143, and a signal processing section 144, instead of the permanent magnet 111, the electromagnetic circuit 112, the magnetic sensor 113, and the signal processing section 118.

The suction cup 141 has a function of sucking the contact target surface Sa toward a void inside the suction cup 141 with use of differential pressure between atmospheric pressure and pressure of the void inside the suction cup 141. For example, the suction cup 141 includes a suction block or a suction pad having a void. The suction cup 141 is provided with a flow path through which the void and the air pump 142 are communicated with each other. For example, the air pump 142 discharges gas from the void inside the suction cup 141 into an outside via the flow path in the suction cup 141 on the basis of a control signal from the signal processing section 144. The pneumatic sensor 143 detects pressure of the void inside the suction cup 141 and outputs a detection signal obtained through the detection to the signal processing section 144. For example, the pneumatic sensor 143 outputs a voltage signal proportional to magnitude of the pressure of the void inside the suction cup 141. Data (detection signal and voltage signal) obtained by the pneumatic sensor 143) is data correlated with the adhesion between the contact surface Sb of the base section 110 and the contact target surface Sa to which the base section 110 is adhered.

The signal processing section 144 includes, for example, a central processing unit (CPU). The signal processing section 144 calculates total moment and total weight (arm 120, fixture section 130, and fixation target object 200) on the basis of various kinds of signals obtained from the joint sections 121 and 122. The total weight and the total moment may be calculated in ways similar to the calculation methods according to the above-described embodiment. The signal processing section 144 further estimates adhesion between the contact surface Sb and the contact target surface Sa on the basis of a detection signal obtained from the pneumatic sensor 143. For example, the signal processing section 144 estimates the adhesion by substituting the detection signal obtained from the pneumatic sensor 143 into an equation (2) listed below, where P represents the pressure of the void inside the suction cup 141. In addition, the signal processing section 144 determines stability of the base section 110 with respect to the contact target surface Sa, on the basis of the calculated total weight, the calculated total moment, and the estimated adhesion.

$$W = ( ( Po - P ) / Po ) \times A \times T \qquad Equation ( 2 )$$

where W represents adhesion (suction force (kg)),
Po represents the atmospheric pressure (101.325 Pa),
P represents the pressure (Pa) of the void inside the suction cup 141,
A represents the area (cm2) of the suction cup 141, and
T represents force of the atmospheric pressure (1 kg/cm2).

Next, operation of the arm stand 100 according to the present modification will be described.

First, the user installs the base section 110 of the arm stand 100 on the contact target surface Sa. Then, the signal processing section 144 estimates inclination of the base section 110 on the basis of a detection signal input from the IMU 114 (Step S101).

Next, the signal processing section 144 calculates total weight and total moment on the basis of various kinds of signals (such as angular information/electric current information of the motors 121a and 122a) obtained from the joint sections 121 and 122 (Step S102). Next, the signal processing section 144 estimates adhesion caused by air pressure on the basis of a detection signal obtained from the pneumatic sensor 143 (Step S103). For example, the signal processing section 144 estimates the adhesion by substituting the detection signal obtained from the pneumatic sensor 143 into the above-listed equation (2), where P represents the pressure of the void inside the suction cup 141. In addition, the signal processing section 144 determines stability of the base section 110 with respect to the contact target surface Sa, on the basis of the calculated total weight, the calculated total moment, and the estimated adhesion (Step S104).

As a result, the signal processing section 144 increases the adhesion by controlling the air pump 142 (Step S105) in a case where it is determined that the arm stand 100 is not stable (N in Step S104). For example, the signal processing section 144 estimates the adhesion that is necessary to obtain the stability against the calculated total weight and total moment, and controls the air pump 142 in such a manner that the estimated adhesion is obtained. In other words, the signal processing section 144 generates a control signal to control the air pump 142 on the basis of a result of determining the stability. Next, the signal processing section 144 reestimates adhesion and redetermines stability (Step S106). As a result, the signal processing section 144 performs a non-installable process (such as the series of processes to fold the arm 120) (Step S107) in a case where it is determined that the arm stand 100 is still not stable (N in Step S106).

Meanwhile, in a case where it is determined that the arm stand 100 is stable (in other words, there is a low possibility that the arm stand 100 will fall down) (Y in Step S104 and Y in Step S106) in Step S104 and Step S106, the signal processing section 144 determines whether or not the setting of at least the movable range is accepted among the movable range and the acceleration of the arm 120 (Step S108). Input of the setting of at least the movable range among the movable range and the acceleration of the arm 120 means causing the arm 120 to operate in the set range.

As a result, the signal processing section 144 calculates maximum change in moment/center of gravity assumed from the setting of any of the movable range or the acceleration of the arm 120 (Step S109) in a case where the setting of at least the movable range is accepted among the movable range and the acceleration of the arm 120 (Y in Step S108). Meanwhile, the signal processing section 144 waits for acceptance of the setting of any of the movable range or the acceleration of the arm 120 (N in Step S108) in a case where the setting of neither the movable range nor the acceleration of the arm 120 is accepted (N in Step S108).

Next, the signal processing section 144 presumes maximum adhesion on the basis of the calculated maximum change in moment/center of gravity (Step S110). Next, the signal processing section 144 determines stability of the base section 110 with respect to the contact target surface Sa, on the basis of the presumed maximum adhesion (Step S111). For example, the signal processing section 144 determines whether or not it is possible for the arm stand 100 to output the presumed maximum adhesion.

As a result, in a case where it is determined that the arm stand 100 is not stable (for example, in a case where it is determined that it is difficult for the arm stand 100 to output the maximum adhesion) (N in Step S111), the signal processing section 144 accepts resetting of any of the movable range or the acceleration of the arm 120 (Step S112), and proceeds to Step S109. Meanwhile, in a case where it is determined that the arm stand 100 is stable in Step S111 (for example, in a case where it is determined that it is possible for the arm stand 100 to output the maximum adhesion) (Yin Step S111), the signal processing section 144 generates a control signal to control the electromagnetic circuit 112 in such a manner that the maximum adhesion is obtained, and outputs the generated control signal to the electromagnetic circuit 112. Subsequently, the signal processing section 144 starts operating the arm 120 (Step S113).

In a case where the signal processing section 144 has accepted the setting of any of the movable range or the acceleration of the arm 120 (Y in Step S114), the signal processing section 144 calculates maximum change in moment/center of gravity assumed from the accepted setting (Step S109). Subsequently, the signal processing section 144 executes Step S110 and Step S111. In a case where the signal processing section 144 has accepted the setting of neither of the movable range nor the acceleration of the arm 120 (N in Step S114), the signal processing section 144 determines whether or not the arm stand 100 has abnormality (Step S115).

Here, for example, the abnormality means abnormality in the inclination of the base section 110 obtained from the IMU 114, abnormality in magnitude of magnetism obtained from the magnetic sensor 113, or the like. As a result, the signal processing section 144 executes the process of folding the arm 120 (Step S116) in a case where the abnormality is detected (Y in Step S115). Meanwhile, the signal processing section 144 ends operation of the arm 120 (Step S117) in a case where the abnormality is not detected (N in Step S115). In such a way, the arm stand 100 operates.

Next, effects of the arm stand 100 according to the present modification will be described.

In the present embodiment, the adhesion between the contact surface Sb of the base section 110 and the contact target surface Sa to which the base section 110 is adhered is estimated on the basis of the data obtained with use of the pneumatic sensor 143, and the stability of the base section 110 with respect to the contact target surface Sa is determined on the basis of the estimated adhesion. This allows the user to recognize whether or not the base section 110 has sufficient stability with respect to the contact target surface Sa when the base section 110 is installed on any surface, and to move the arm 120 coupled to the base section 110 in such a manner that the stability of the base section 110 is ensured with respect to the contact target surface Sa. Therefore, it is possible to objectively recognize the stability or to control operation of the arm 120 in such a manner that the stability is ensured.

In the present modification, the control signal to control the air pump 142 provided in the base section 110 is generated on the basis of a result of determining the stability. This makes it possible to control the air pump 142 in such a manner that the adhesion of the base section 110 to the contact target surface Sa increases. Therefore, it is possible to control operation of the arm 120 in such a manner that the stability is ensured.

In the present modification, the maximum adhesion that is necessary to ensure the stability of the base section 110 with respect to the contact target surface Sa is calculated on the basis of at least the movable range among the movable range and the acceleration of the arm 120. In addition, the control signal to control the air pump 142 is generated in such a manner that the calculated maximum adhesion is obtained. Therefore, it is possible to control operation of the arm 120 in such a manner that the stability is ensured.

In the present modification, the maximum adhesion is calculated on the basis of the movable range and the acceleration obtained through input from the user. This makes it possible to generate the control signal to control the air pump 142 in such a manner that the calculated maximum adhesion is obtained. Therefore, it is possible to control operation of the arm 120 in such a manner that the stability is ensured.

### Modification 1-2

In the above-described embodiment and modification thereof, the arm 120 is displaced by driving the motors. However, in the above-described embodiment and modification thereof, the arm 120 may be displaced by hand.

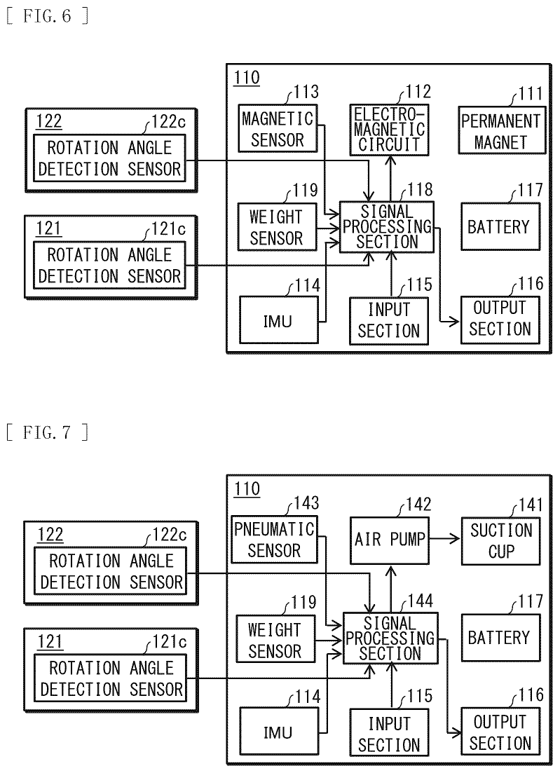

At this time, for example, as illustrated in FIG. 6, the joint section 121 includes the rotation angle detection sensor 121c, but the motor 121a and the driving section 121b are omitted. In addition, for example, as illustrated in FIG. 7, the joint section 122 includes the rotation angle detection sensor 122c, but the motor 122a and the driving section 122b are omitted. In addition, for example, as illustrated in FIG. 6 and FIG. 7, the base section 110 includes a weight sensor 119. The weight sensor 119 measures weights of the arm 120, the fixture section 130, and the fixation target object 200, and outputs measurement data obtained through the measurement to the signal processing section 118 or 144 as the total weight. The signal processing section 118 or 144 calculates the total moment on the basis of the total weight obtained from the weight sensor 119 and signals (angular information of first arm 123 and second arm 124) obtained from the joint sections 121 and 122 (rotation angle detection sensors 121c and 122c).

Even in such a case, the rotation angle detection sensors 121c and 122c detect rotation angles of the first arm 123 and the second arm 124 that are displaced by hand, and adhesion between the contact surface Sb of the base section 110 and the contact target surface Sa to which the base section 110 is adhered is estimated on the basis of results of the detection. Therefore, in a way similar to the above-described embodiment and the modification thereof, it is possible to objectively recognize the stability or to control operation of the arm 120 in such a manner that the stability is ensured.

### Modification 1-3

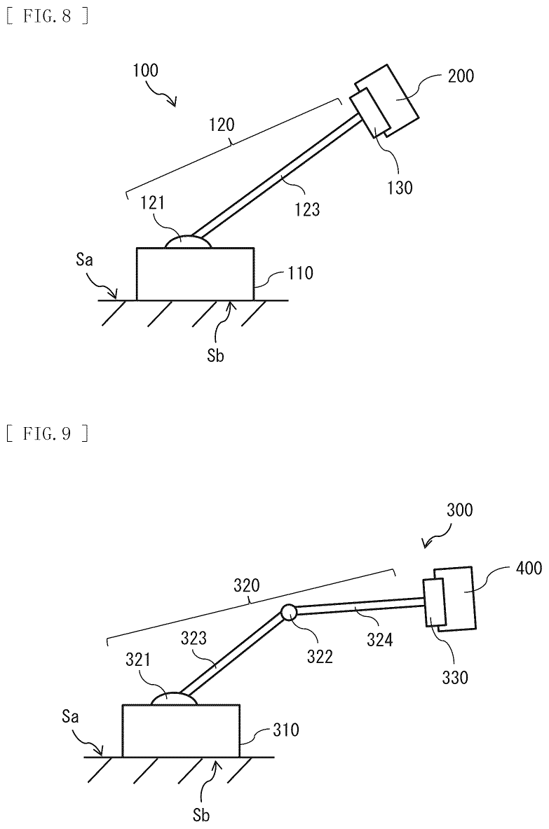

In the above-described embodiment and the modifications thereof, the plurality of joint sections 121 and 122 are installed. However, for example, as illustrated in FIG. 8, it is also possible to install only one joint section 121.

### 3. Second Embodiment

### [Configuration]

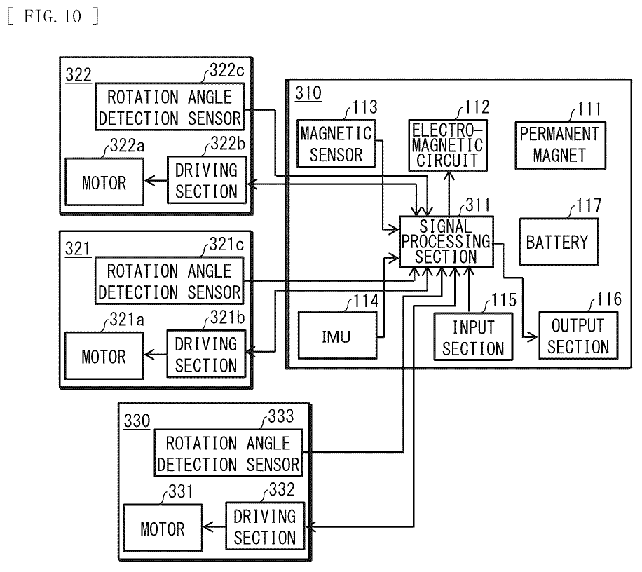

FIG. 9 illustrates a schematic configuration example of a robotic arm 300 according to a second embodiment of the present disclosure. FIG. 10 illustrates a functional block example of the robotic arm 300. The robotic arm 300 is a device for fixing a holding target object 400 in the air. For example, as illustrated in FIG. 9, the robotic arm 300 includes a base section 310, an arm 320, and a holding section 330.

The base section 310 has a bottom surface that is adhered to and in contact with a contact target surface Sa. Hereinafter, the bottom surface of the base section 110 will be referred to as a contact surface Sb. The contact target surface Sa is a surface of a predetermined object (for example, a table, wall, or mobile object (such as a vehicle or drone)). According to the present embodiment, a permanent magnet and an electromagnet are installed near the contact surface Sb of the base section 310, the contact target surface Sa of the predetermined object includes metal material, and the contact surface Sb of the base section 310 is adhered to the contact target surface Sa through magnetic force of the permanent magnet and electromagnet. The magnetic force of the permanent magnet and electromagnet corresponds to a specific example of the “adhesion” according to the present disclosure.

### (Base Section 310)

For example, as illustrated in FIG. 10, the base section 310 includes the permanent magnet 111, the electromagnetic circuit 112, the magnetic sensor 113, the IMU 114, the input section 115 the output section 116, the battery 117, and a signal processing section 311.

The signal processing section 311 includes, for example, a central processing unit (CPU). The signal processing section 311 calculates total moment and total weight (arm 320, holding section 330, and holding target object 400) on the basis of various kinds of signals obtained from the holding section 330 and joint sections 321 and 322. The signal processing section 311 further estimates adhesion between the contact surface Sb and the contact target surface Sa on the basis of a detection signal obtained from the magnetic sensor 113. For example, the signal processing section 311 derives a difference between a detection signal obtained from the magnetic sensor 113 when the contact surface Sb is not adhered to the contact target surface Sa (non-adhered state) and a detection signal obtained from the magnetic sensor 113 when the contact surface Sb is adhered to the contact target surface Sa (adhered state). For example, the signal processing section 311 estimates the adhesion by substituting the different obtained as described above into the above-listed equation (1), where ΔB represents change in magnetic flux density. It is to be noted that the estimation of the adhesion is not limited to the above-listed equation (1). In addition, the signal processing section 311 determines stability of the base section 310 with respect to the contact target surface Sa, on the basis of the calculated total weight, the calculated total moment, and the estimated adhesion.

### (Arm 320)

For example, as illustrated in FIG. 9, the arm 120 includes joint sections 321, 322, a first arm 323, and a second arm 324. For example, as illustrated in FIG. 10, the joint section 321 includes a motor 321a, a driving section 321b, and a rotation angle detection sensor 321c. The motor 321a pivots the first arm 323. The driving section 321b drives the motor 321a under the control of the signal processing section 311. The rotation angle detection sensor 321c detects a rotation angle of the motor 321a. The driving section 321b outputs a measurement value of electric current to be applied to the motor 321a (electric current information of motor 321a), to the signal processing section 311. The rotation angle detection sensor 321c outputs the detected rotation angle of the motor 321a (angular information of motor 321a), to the signal processing section 311. For example, the rotation angle detection sensor 321c includes an encoder.

For example, as illustrated in FIG. 10, the joint section 322 includes a motor 322a, a driving section 322b, and a rotation angle detection sensor 322c. The motor 322a pivots the second arm 324. The driving section 322b drives the motor 322a under the control of the signal processing section 311. The rotation angle detection sensor 322c detects a rotation angle of the motor 322a. The driving section 322b outputs a measurement value of electric current to be applied to the motor 322a (electric current information of motor 322a), to the signal processing section 311. The rotation angle detection sensor 322c outputs the detected rotation angle of the motor 322a (angular information of motor 322a), to the signal processing section 311. For example, the rotation angle detection sensor 322c includes an encoder.

One end of the first arm 323 is fixed to a rotation shaft of the motor 321a of the joint section 321, and another end of the first arm 323 is fixed to a casing that fixes the motor 321a of the joint section 322. One end of the second arm 324 is fixed to a rotation shaft of the motor 322a of the joint section 322, and another end of the second arm 324 is fixed to the holding section 330.

### (Holding Section 330)

The holding section 330 includes a mechanism of holding the holding target object 400. The holding section 330 is movably coupled to the one end of the second arm 324. For example, as illustrated in FIG. 10, the holding section 330 includes a motor 331, a driving section 332, and a rotation angle detection sensor 333. The motor 331 pivots the mechanism of holding the holding target object 400. The driving section 332 drives the motor 331 under the control of the signal processing section 311. The rotation angle detection sensor 333 detects a rotation angle of the motor 331. The driving section 332 outputs a measurement value of electric current to be applied to the motor 331 (electric current information of motor 331), to the signal processing section 311. The rotation angle detection sensor 333 outputs the detected rotation angle of the motor 331 (angular information of motor 331), to the signal processing section 311. For example, the rotation angle detection sensor 333 includes an encoder.

For example, the signal processing section 311 calculates an angle of the first arm 323 with respect to the joint section 321, from the angular information of the motor 321a. For example, the signal processing section 311 calculates an angle of the second arm 324 with respect to the joint section 322, from the angular information of the motor 322a. For example, the signal processing section 311 calculates an angle of the mechanism of holding the holding target object 400 with respect to the second arm 324, from the angular information of the motor 331. For example, the signal processing section 311 estimates torque applied to the holding section 330 from the electric current information of the motors 321a, 322a, and 331, and estimates weights of the holding target object 400 and the holding section 330 from the estimated torque. In a case where the weight of the arm 320 is previously known, the signal processing section 311 calculates the total weight by adding the known weight of the arm 320 and the estimated weights of the holding target object 400 and the holding section 330, for example.

For example, the signal processing section 311 estimates a total center-of-gravity position from the calculated total weight, the calculated angle of the first arm 323, the calculated angle of the second arm 324, and the calculated angle of the mechanism of holding the holding target object 400. For example, the signal processing section 311 calculates moment (total moment) applied to the contact surface Sb on the basis of the estimated total center-of-gravity position, the calculated total weight, and inclination of the base section 310 obtained by the IMU 114.

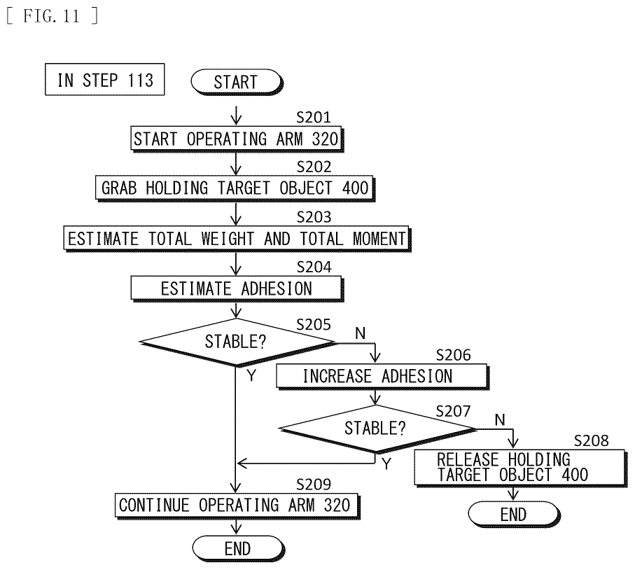

Next, with reference to FIG. 11, operation of the robotic arm 300 will be described. FIG. 11 illustrates an example of the operation of the robotic arm 300.

First, the user installs the base section 310 of the robotic arm 300 on the contact target surface Sa. At this time, the holding target object 400 is not held by the robotic arm 300 yet. Then, the signal processing section 311 estimates inclination of the base section 310 on the basis of a detection signal input from the IMU 114 (Step S101).

Next, the signal processing section 311 calculates total weight and total moment on the basis of various kinds of signals (such as angular information/electric current information of the motors 321a, 322a, and 331) obtained from the joint sections 321, 322, and the holding section 330 (Step S102). Next, the signal processing section 311 estimates adhesion (magnetic force of the permanent magnet and electromagnet) on the basis of a detection signal obtained from the magnetic sensor 113 (Step S103). For example, the signal processing section 311 estimates the adhesion by measuring change in magnetic flux density between a contact state and a non-contact state from the detection signal obtained from the magnetic sensor 113 and substituting the measured change in magnetic flux density into the above-listed equation (1). The detection signal in the non-contact state may be acquired immediately before the user installs the base section 310 of the robotic arm 300 on the contact target surface Sa. Alternatively, a memory or the like built in the base section 310 may previously store a detection signal in the non-contact state that is previously acquired before shipment of the robotic arm 300 from a factory.

In addition, the signal processing section 311 determines stability of the base section 310 with respect to the contact target surface Sa, on the basis of the calculated total weight, the calculated total moment, and the estimated adhesion (Step S205). As a result, the signal processing section 311 increases the adhesion by controlling the electromagnetic circuit 112 (Step S105) in a case where it is determined that the robotic arm 300 is not stable (in other words, there is a high possibility that the robotic arm 300 will fall down) (N in Step S104). For example, the signal processing section 311 estimates the adhesion that is necessary to obtain the stability against the calculated total weight and total moment, and controls the electromagnetic circuit 112 in such a manner that the estimated adhesion is obtained. Next, the signal processing section 311 reestimates adhesion and redetermines stability (Step S106). As a result, the signal processing section 311 performs a non-installable process (such as the series of processes to fold the arm 320) (Step S107) in a case where it is determined that the robotic arm 300 is still not stable (N in Step S207).

Meanwhile, in a case where it is determined that the robotic arm 300 is stable (in other words, there is a low possibility that the robotic arm 300 will fall down) (Y in Step S104 and Y in Step S106) in Step S104 and Step S106, the signal processing section 311 determines whether or not the setting of at least the movable range is accepted among the movable range and the acceleration of the arm 120 (Step S108). Input of the setting of at least the movable range among the movable range and the acceleration of the arm 120 means causing the arm 120 to operate in the set range.

As a result, the signal processing section 311 calculates maximum change in moment/center of gravity assumed from the setting of any of the movable range or the acceleration of the arm 320 (Step S109) in a case where the setting of at least the movable range is accepted among the movable range and the acceleration of the arm 320 (Yin Step S108). Meanwhile, the signal processing section 311 waits for acceptance of the setting of any of the movable range or the acceleration of the arm 320 (N in Step S108) in a case where the setting of neither the movable range nor the acceleration of the arm 320 is accepted (N in Step S108).

Next, the signal processing section 311 presumes maximum adhesion on the basis of the calculated maximum change in moment/center of gravity (Step S110). Next, the signal processing section 311 determines stability of the base section 310 with respect to the contact target surface Sa, on the basis of the presumed maximum adhesion (Step S111). For example, the signal processing section 311 determines whether or not it is possible for the robotic arm 300 to output the presumed maximum adhesion.

As a result, in a case where it is determined that the robotic arm 300 is not stable (for example, in a case where it is determined that it is difficult for the robotic arm 300 to output the maximum adhesion) (N in Step S111), the signal processing section 311 accepts resetting of any of the movable range or the acceleration of the arm 320 (Step S112), and proceeds to Step S109. Meanwhile, in a case where it is determined that the robotic arm 300 is stable in Step S111 (for example, in a case where it is determined that it is possible for the robotic arm 300 to output the maximum adhesion) (Y in Step S111), the signal processing section 311 generates a control signal to control the electromagnetic circuit 112 in such a manner that the maximum adhesion is obtained, and outputs the generated control signal to the electromagnetic circuit 112. Subsequently, the signal processing section 311 starts operation of the arm 320 (Step S113).

Here, details of the operation of the arm 320 will be described.

First, the user instructs the robotic arm 300 to grab the holding target object 400. Then, the signal processing section 311 executes a series of operation of grabbing the holding target object 400 with the holding section 330. As a result, the holding section 330 grabs the holding target object 400 (Step S202). In a state where the holding section 330 is slightly lifting the holding target object 400, the signal processing section 311 calculates total weight and total moment on the basis of various kinds of signals (such as angular information/electric current information of the motors 321a, 322a, and 331) obtained from the joint sections 321, 322, and the holding section 330 (Step S203). Next, the signal processing section 311 estimates adhesion (magnetic force of the permanent magnet and electromagnet) on the basis of a detection signal obtained from the magnetic sensor 113 (Step S204). For example, the signal processing section 311 estimates the adhesion by measuring change in magnetic flux density between a contact state and a non-contact state from the detection signal obtained from the magnetic sensor 113 and substituting the measured change in magnetic flux density into the above-listed equation (1).

In addition, the signal processing section 311 determines stability of the base section 310 with respect to the contact target surface Sa, on the basis of the calculated total weight, the calculated total moment, and the estimated adhesion (Step S205). As a result, the signal processing section 311 increases the adhesion by controlling the electromagnetic circuit 112 (Step S206) in a case where it is determined that the base section 310 is not stable (N in Step S205). For example, the signal processing section 311 estimates the adhesion that is necessary to obtain the stability against the calculated total weight and total moment, and controls the electromagnetic circuit 112 in such a manner that the estimated adhesion is obtained. Next, the signal processing section 311 reestimates adhesion and redetermines stability (Step S207). As a result, the signal processing section 311 performs a non-installable process (such as a series of processes to separate the holding target object 400 from the holding section 330) (Step S208) in a case where it is determined that the base station 310 is still not stable (N in Step S207).

Meanwhile, in a case where it is determined that the base section 310 is stable in Step S205 and Step S207 (Y in Step S205 and Y in Step S207), the signal processing section 311 continues operating the arm 320 (Step S209). At this time, the signal processing section 311 may execute a process that is similar to Steps S114 to S117 described above if necessary.

### [Effects]

Next, effects of the robotic arm 300 will be described.

In the present embodiment, the adhesion between the contact surface Sb of the base section 310 and the contact target surface Sa to which the base section 310 is adhered is estimated on the basis of the data obtained with use of the magnetic sensor 113, and the stability of the base section 310 with respect to the contact target surface Sa is determined on the basis of the estimated adhesion.

This allows the user to recognize whether or not the base section 310 has sufficient stability with respect to the contact target surface Sa when the base section 310 is installed on any surface, and to move the arm 320 coupled to the base section 310 in such a manner that the stability of the base section 310 is ensured with respect to the contact target surface Sa. Therefore, it is possible to objectively recognize the stability or to control operation of the arm 320 in such a manner that the stability is ensured.

In the present embodiment, the control signal to control the electromagnetic circuit 112 provided in the base section 310 is generated on the basis of a result of determining the stability. This makes it possible to control the electromagnetic circuit 112 in such a manner that the adhesion of the base section 310 to the contact target surface Sa increases. Therefore, it is possible to control operation of the arm 320 in such a manner that the stability is ensured.

In the present embodiment, the maximum adhesion that is necessary to ensure the stability of the base section 310 with respect to the contact target surface Sa is calculated on the basis of at least the movable range among the movable range and the acceleration of the arm 320. In addition, the control signal to control the electromagnetic circuit 112 is generated in such a manner that the calculated maximum adhesion is obtained. Therefore, it is possible to control operation of the arm 320 in such a manner that the stability is ensured.

In the present embodiment, the maximum adhesion is calculated on the basis of the movable range and the acceleration obtained through input from the user. This makes it possible to generate the control signal to control the electromagnetic circuit 112 in such a manner that the calculated maximum adhesion is obtained. Therefore, it is possible to control operation of the arm 320 in such a manner that the stability is ensured.

### 4. Modifications of Second Embodiment

Next, modifications of the robotic arm 300 according to the above-described second embodiment will be described.

### Modification 2-1

FIG. 12 illustrates a modification of the functional blocks of the robotic arm 300. A robotic arm 300 according to the present modification is a robotic arm that utilizes not the adhesion caused by magnetic force but adhesion caused by air pressure. The air pressure corresponds to a specific example of the “adhesion” according to the present disclosure. The robotic arm 300 according to the present modification includes the suction cup 141, the air pump 142, the pneumatic sensor 143, and a signal processing section 312, instead of the permanent magnet 111, the electromagnetic circuit 112, the magnetic sensor 113, and the signal processing section 311.

The signal processing section 312 includes, for example, a central processing unit (CPU). The signal processing section 312 calculates total moment and total weight (for example, arm 320, holding section 330, and holding target object 400) on the basis of various kinds of signals obtained from the joint sections 121 and 122. The total weight and the total moment may be calculated in ways similar to the calculation methods according to the above-described second embodiment. The signal processing section 312 further estimates adhesion between the contact surface Sb and the contact target surface Sa on the basis of a detection signal obtained from the pneumatic sensor 143. For example, the signal processing section 312 estimates the adhesion by substituting the detection signal obtained from the pneumatic sensor 143 into the above-listed equation (2), where P represents the pressure of the void inside the suction cup 141. In addition, the signal processing section 312 determines stability of the base section 310 with respect to the contact target surface Sa, on the basis of the calculated total weight, the calculated total moment, and the estimated adhesion.

The operation of the robotic arm 300 according to the present modification is executed by substituting control by air pressure for control by magnetic force in the series of operation of the robotic arm 300 according to the second embodiment.

In the present embodiment, the adhesion between the contact surface Sb of the base section 310 and the contact target surface Sa to which the base section 310 is adhered is estimated on the basis of the data obtained with use of the pneumatic sensor 143, and the stability of the base section 310 with respect to the contact target surface Sa is determined on the basis of the estimated adhesion. This allows the user to recognize whether or not the base section 310 has sufficient stability with respect to the contact target surface Sa when the base section 310 is installed on any surface, and to move the arm 320 coupled to the base section 310 in such a manner that the stability of the base section 310 is ensured with respect to the contact target surface Sa. Therefore, it is possible to objectively recognize the stability or to control operation of the arm 320 in such a manner that the stability is ensured.

In the present modification, the control signal to control the air pump 142 provided in the base section 310 is generated on the basis of a result of determining the stability. This makes it possible to control the air pump 142 in such a manner that the adhesion of the base section 310 to the contact target surface Sa increases. Therefore, it is possible to control operation of the arm 320 in such a manner that the stability is ensured.

In the present modification, the maximum adhesion that is necessary to ensure the stability of the base section 310 with respect to the contact target surface Sa is calculated on the basis of at least the movable range among the movable range and the acceleration of the arm 320. In addition, the control signal to control the air pump 142 is generated in such a manner that the calculated maximum adhesion is obtained. Therefore, it is possible to control operation of the arm 320 in such a manner that the stability is ensured.

In the present modification, the maximum adhesion is calculated on the basis of the movable range and the acceleration obtained through input from the user. This makes it possible to generate the control signal to control the air pump 142 in such a manner that the calculated maximum adhesion is obtained. Therefore, it is possible to control operation of the arm 320 in such a manner that the stability is ensured.

### 5. Modification Common to Both Embodiments

Next, modifications common to both of the embodiments will be described.

### Modification 3-1

In the above-described embodiments and the modifications thereof, a mobile object (such as a vehicle or drone) may handle a portion of the arithmetic process of the arm stand 100 and the robotic arm 300.

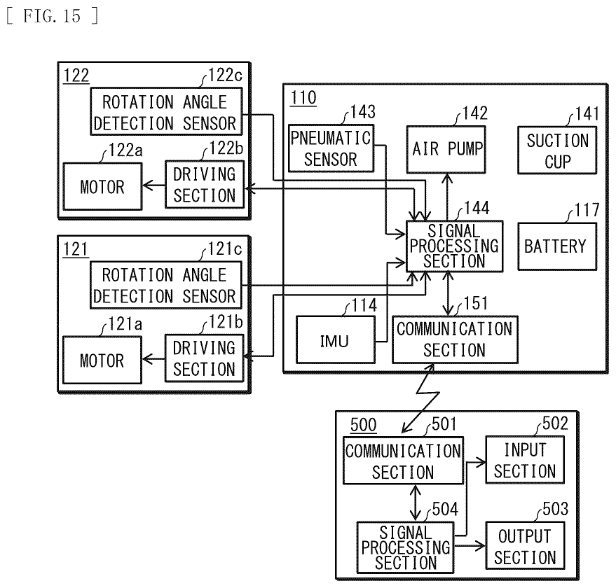

For example, as illustrated in FIG. 13, it is assumed that the arm stand 100 is adhered to a surface of a mobile object 500 (such as a vehicle or drone). At this time, for example, as illustrated in FIG. 14 and FIG. 15, the mobile object 500 may include a structural element of processing data output from the arm stand 100. At this time, the arm stand 100 may include a communication section 151 that communicates with the mobile object 500. The mobile object 500 may include a communication section 501 and a signal processing section 504. The communication section 501 communicates with the arm stand 100 (communication section 151). The signal processing section 504 processes data acquired from the arm stand 100 via the communication section 501. The signal processing section 504 includes, for example, a central processing unit (CPU). The mobile object 500 may further include an input section 502 and an output section 503. The input section 502 accepts input from users. The output section 503 outputs data from the signal processing section 504 to an outside. For example, the output section 503 includes a display or the like.

The signal processing sections 118 and 144 may output the various kinds of signals obtained from the joint sections 121 and 122 and the detection signal obtained from the magnetic sensor 113 or the pneumatic sensor 143, to the mobile object 500 via the communication section 151. At this time, the signal processing section 504 may execute the series of processes in Steps S101 to S117 described above, on the basis of the various kinds of signals obtained from the joint sections 121 and 122 and the detection signal obtained from the magnetic sensor 133 or the pneumatic sensor 143.

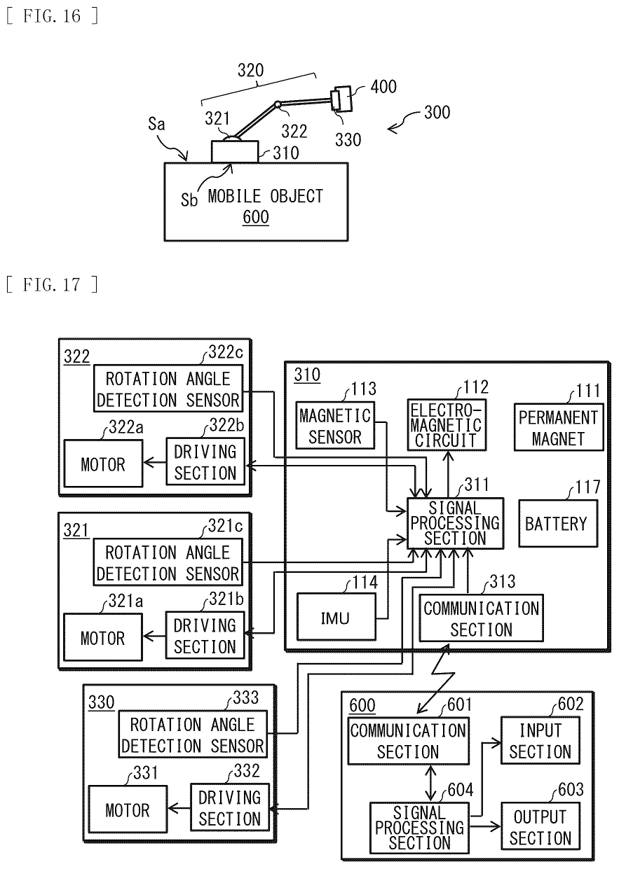

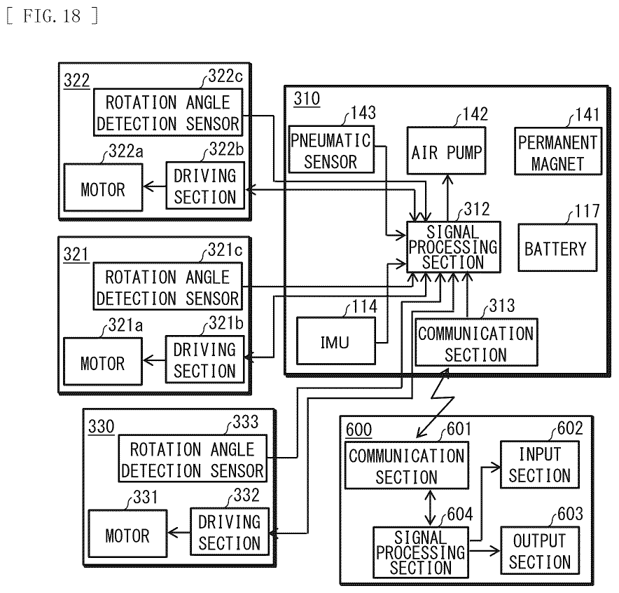

For example, as illustrated in FIG. 16, it is assumed that the robotic arm 300 is adhered to a surface of a mobile object 600 (such as a vehicle or drone). At this time, for example, as illustrated in FIG. 17 and FIG. 18, the mobile object 600 may include a structural element of processing data output from the robotic arm 300. At this time, the robotic arm 300 may include a communication section 313 that communicates with the mobile object 600. The mobile object 600 may include a communication section 601 and a signal processing section 604. The communication section 601 communicates with the robotic arm 300 (communication section 313). The signal processing section 604 processes data acquired from the robotic arm 300 via the communication section 601. The signal processing section 604 includes, for example, a central processing unit (CPU). The mobile object 600 may further include an input section 602 and an output section 603. The input section 602 accepts input from users. The output section 603 outputs data from the signal processing section 604 to an outside. For example, the output section 603 includes a display or the like.

The signal processing sections 311 and 312 may output the various kinds of signals obtained from the joint sections 121 and 122 and the detection signal obtained from the magnetic sensor 113 or the pneumatic sensor 143, to the mobile object 600 via the communication section 601. At this time, the signal processing section 604 may execute the series of processes in Steps S101 to S117 described above, on the basis of the various kinds of signals obtained from the joint sections 121 and 122 and the detection signal obtained from the magnetic sensor 113 or the pneumatic sensor 143.

As described above, it is possible to reduce a burden of the arithmetic processes on the arm stand 100 and the robotic arm 300 by causing the mobile objects 500 and 600 to handle the series of processes in Steps S101 to S117 described above.

### Modification 3-2

In the above-described embodiments and the modifications thereof, it is possible to appropriately set a timing of determining (deciding) the above-described stability.

In the above-described embodiments and the modifications thereof, the signal processing sections 118, 144, 311, 312, 504, and 604 may determine the stability when the base section 110 or 310 is in contact with the contact target surface Sb. Alternatively, in the above-described embodiments and the modifications thereof, the signal processing sections 118, 144, 311, 312, 504, and 604 may determine the stability when the arm 120 or 320 movably coupled to the base section 110 or 310 starts moving.

In the second embodiment and the modifications thereof, the signal processing sections 311, 312, and 604 may determine the stability when an object (holding target object 400) is lifted by the holding section 330 coupled to the tip of the arm 320. Alternatively, in the second embodiments and the modifications thereof, the signal processing sections 311, 312, and 604 may determine the stability when the mobile object 500 or 600 starts moving.

By determining (deciding) the stability at any of the above-described timings, it is possible to reduce a possibility that the arm stand 100 or the robotic arm 300 may falls down due to insufficient adhesion during the subsequent operation.

The present disclosure has been described above with reference to the embodiments and the modifications thereof. However, the present disclosure is not limited thereto, and various kinds of modifications thereof can be made. It is to be noted that the effects described in the present specification are merely examples. The effects of the present disclosure are not limited to those described in the present specification. The present disclosure may include effects other than those described in the present specification.

For example, the present disclosure may be configured as follows.

(1)

An information processing device including:
an estimation section that estimates adhesion between a contact surface of a base section and a contact target surface to which the base section is attached, on a basis of data that is obtained with use of a sensor and correlated with the adhesion; and
a determination section that determines stability of the base section with respect to the contact target surface, on a basis of the adhesion estimated by the estimation section.
   (2)

The information processing device according to (1), in which
the sensor includes a magnetic sensor, and
the information processing device further includes a signal processing section that generates a control signal on a basis of a result of determination made by the determination section, the control signal controlling an electromagnetic circuit provided in the base section.
   (3)

The information processing device according to (1), in which
the sensor includes a pneumatic sensor, and the information processing device further includes a signal processing section that generates
a control signal on a basis of a result of determination made by the determination section, the control signal controlling an air pump provided in the base section.
   (4)

The information processing device according to (2) or (3), in which the signal processing section calculates maximum adhesion necessary to ensure the stability of the base section with respect to the contact target surface, on a basis of at least a movable range among the movable range and acceleration of an arm that is movably coupled to the base section, and generates the control signal to obtain the maximum adhesion calculated.

(5)

The information processing device according to (4), in which the signal processing section calculates the maximum adhesion on a basis of the movable range and the acceleration obtained through input from a user.

(6)

The information processing device according to any one of (1) to (5), in which the determination section determines the stability when the base section comes into contact with the contact target surface.

(7)

The information processing device according to (6), in which the determination section determines the stability when the arm that is movably coupled to the base section starts moving.

(8)

The information processing device according to (7), in which the determination section determines the stability when a holding section that is coupled to a tip of the arm lifts an object.

(9)

The information processing device according to any one of (6) to (8), in which the determination section determines the stability when a mobile object having the contact target surface starts moving.

(10)

The information processing device according to any one of (1) to (9), in which the estimation section and the determination section are provided in a mobile object having the contact target surface.

(11)

The information processing device according to any one of (1) to (9), in which the estimation section and the determination section are provided in the base section.

(12)

The information processing device according to (2) or (3), in which the signal processing section is provided in the base section.

(13)

An information processing method including:
estimating adhesion between a contact surface of a base section and a contact target surface to which the base section is attached, on a basis of data that is obtained with use of a sensor and correlated with the adhesion; and
determining stability of the base section with respect to the contact target surface, on a basis of the adhesion estimated.
   (14)

The information processing method according to (13), in which
the sensor includes a magnetic sensor, and
the information processing method further includes generating a control signal on a basis of a determination result obtained through the determination, the control signal controlling an electromagnetic circuit provided in the base section.
   (15)

The information processing method according to (13), in which
the sensor includes a pneumatic sensor, and
the information processing method further includes generating a control signal on a basis of a determination result obtained through the determination, the control signal controlling an air pump provided in the base section.

When using the information processing device according to the first aspect of the present disclosure and the information processing method according to the second aspect of the present disclosure, the adhesion between the contact surface of the base section and the contact target surface to which the base section is adhered is estimated on the basis of the data obtained with use of the sensor, and the stability of the base section with respect to the contact target surface is determined on the basis of the estimated adhesion. This allows users to recognize whether or not the base section has sufficient stability with respect to the contact target surface when the base section is installed on any surface, and to move the arm coupled to the base section in such a manner that the stability of the base section is ensured with respect to the contact target surface. Therefore, it is possible to objectively recognize the stability or to control operation of the arm portion in such a manner that the stability is ensured.

The present application claims the benefit of Japanese Priority Patent Application JP2021-192214 filed with the Japan Patent Office on Nov. 26, 2021, the entire contents of which are incorporated herein by reference.

It should be understood by those skilled in the art that various modifications, combinations, sub-combinations and alternations may occur depending on design requirements and other factors insofar as they are within the scope of the appended claims or the equivalents thereof.

1. An information processing device comprising:
an estimation section that estimates adhesion between a contact surface of a base section and a contact target surface to which the base section is attached, on a basis of data that is obtained with use of a sensor and correlated with the adhesion; and
a determination section that determines stability of the base section with respect to the contact target surface, on a basis of the adhesion estimated by the estimation section.

2. The information processing device according to claim 1, wherein
the sensor comprises a magnetic sensor, and
the information processing device further comprises a signal processing section that generates a control signal on a basis of a result of determination made by the determination section, the control signal controlling an electromagnetic circuit provided in the base section.

3. The information processing device according to claim 1, wherein
the sensor comprises a pneumatic sensor, and
the information processing device further comprises a signal processing section that generates a control signal on a basis of a result of determination made by the determination section, the control signal controlling an air pump provided in the base section.

4. The information processing device according to claim 2, wherein the signal processing section calculates maximum adhesion necessary to ensure the stability of the base section with respect to the contact target surface, on a basis of at least a movable range among the movable range and acceleration of an arm that is movably coupled to the base section, and generates the control signal to obtain the maximum adhesion calculated.

5. The information processing device according to claim 3, wherein the signal processing section calculates maximum adhesion necessary to ensure the stability of the base section with respect to the contact target surface, on a basis of at least a movable range among the movable range and acceleration of an arm that is movably coupled to the base section, and generates the control signal to obtain the maximum adhesion calculated.

6. The information processing device according to claim 4, wherein the signal processing section calculates the maximum adhesion on a basis of the movable range and the acceleration obtained through input from a user.

7. The information processing device according to claim 5, wherein the signal processing section calculates the maximum adhesion on a basis of the movable range and the acceleration obtained through input from a user.

8. The information processing device according to claim 1, wherein the determination section determines the stability when the base section comes into contact with the contact target surface.

9. The information processing device according to claim 8, wherein the determination section determines the stability when the arm that is movably coupled to the base section starts moving.

10. The information processing device according to claim 9, wherein the determination section determines the stability when a holding section that is coupled to a tip of the arm lifts an object.

11. The information processing device according to claim 8, wherein the determination section determines the stability when a mobile object having the contact target surface starts moving.

12. The information processing device according to claim 1, wherein the estimation section and the determination section are provided in a mobile object having the contact target surface.

13. The information processing device according to claim 1, wherein the estimation section and the determination section are provided in the base section.

14. The information processing device according to claim 2, wherein the signal processing section is provided in the base section.

15. The information processing device according to claim 3, wherein the signal processing section is provided in the base section.

16. An information processing method comprising:
estimating adhesion between a contact surface of a base section and a contact target surface to which the base section is attached, on a basis of data that is obtained with use of a sensor and correlated with the adhesion; and
determining stability of the base section with respect to the contact target surface, on a basis of the adhesion estimated.

17. The information processing method according to claim 16, wherein
the sensor comprises a magnetic sensor, and
the information processing method further comprises generating a control signal on a basis of a determination result obtained through the determination, the control signal controlling an electromagnetic circuit provided in the base section.

18. The information processing method according to claim 16, wherein
the sensor comprises a pneumatic sensor, and
the information processing method further comprises generating a control signal on a basis of a determination result obtained through the determination, the control signal controlling an air pump provided in the base section.
